(19) United States
(12) Patent Application Publication
(10) Pub. No.: US 2023/0143914 A1
(43) Pub. Date: May 11, 2023

(54) BAG WITH TEAR LINE AND NOTCH

(71) Applicant: PEEL PLASTIC PRODUCTS LIMITED, Brampton (CA)

(72) Inventor: Julia Amanda LOBO, Toronto (CA)

(21) Appl. No.: 18/052,405

(22) Filed: Nov. 3, 2022

Related U.S. Application Data
(60) Provisional application No. 63/277,146, filed on Nov. 8, 2021.

(51) Int. Cl. B65D 75/58; B65B 43/02; B65B 61/18

(52) U.S. Cl. CPC B65D 75/5805; B65B 43/02; B65B 61/182; B65D 2575/58; B65D 2575/30

(57) ABSTRACT

There is provided a plastic film bag that includes: a front panel; and a back panel affixed to the front panel along edges of the front panel and back panel. The front panel, back panel, or both, define at least one primary tear notch and a primary tear line terminating at the primary tear notch. A plurality of secondary tear mechanisms are defined at edges within the primary tear notch. In some cases, the plurality of secondary tear mechanisms include notches spaced along a boundary of the edge defining the primary tear notch, the secondary notches smaller in size than the primary tear notch.

### FIELD OF THE INVENTION

This invention relates to a bag or pouch made of plastic film and in particular to arrangements for easy opening of such bags.

### BACKGROUND

A dual web vertical form-fill-seal manufacturing system and process can be used for manufacturing two-sided sealed bags or pouches.

### SUMMARY

In an aspect, there is provided a plastic film bag comprising: a front panel; and a back panel affixed to the front panel along edges of the front panel and back panel, wherein the front panel, the back panel, or both, define at least one primary tear notch and a primary tear line terminating at the primary tear notch, and wherein a plurality of secondary tear mechanisms are defined within the primary tear notch.

In a particular case of the plastic film bag, the plurality of secondary tear mechanisms comprise notches spaced along a boundary of the edge defining the primary tear notch, the secondary notches smaller in size than the primary tear notch.

In another case of the plastic film bag, the secondary notches are defined by a plurality of portions of the edge extending into the space defined by the primary notch.

In yet another case of the plastic film bag, the plurality of portions are triangular shaped teeth.

In yet another case of the plastic film bag, the secondary notches are defined by a plurality of indentations inwards at the edge defined by the primary notch.

In yet another case of the plastic film bag, the plurality of secondary tear mechanisms comprise a plurality of radiating secondary tear lines joined at the end of the primary tear line.

In yet another case of the plastic film bag, the primary tear line extends from the edge defining the primary tear notch to an opposing edge of the front panel or back panel.

In yet another case of the plastic film bag, the front panel and back panel, or both, define two primary tear notches on opposing edges, and the primary tear line extends between the two primary tear notches.

In another aspect, there is provided a method for fabricating a plastic film bag, the method comprising: fabricating a front panel; fabricating a back panel; and affixing to the front panel to the back panel along edges of the front panel and back panel, wherein fabricating the front panel and fabricating the back panel comprises forming at least one primary tear notch and a primary tear line terminating at the primary tear notch, and forming a plurality of secondary tear mechanisms located at, or near, a boundary of the edge within the primary tear notch.

In a particular case of the method, the plurality of secondary tear mechanisms comprise notches spaced along a boundary of the edge defining the primary tear notch, the secondary notches smaller in size than the primary tear notch.

In another case of the method, the secondary notches are formed by a plurality of portions of the edge extending into the space defined by the primary notch.

In yet another case of the method, the plurality of portions comprise triangular shaped teeth.

In yet another case of the method, the secondary notches are formed by cutting a plurality of indentations inwards at the edge defined by the primary notch.

In yet another case of the method, the plurality of secondary tear mechanisms comprise a plurality of radiating secondary tear lines joined at the end of the primary tear line.

In yet another case of the method, the primary tear line extends from the edge defining the primary tear notch to an opposing edge of the front panel or back panel.

In yet another case of the method, the front panel and back panel each are fabricated with two primary tear notches formed on opposing edges, and the primary tear line extends between the two primary tear notches.

### BRIEF DESCRIPTION OF THE DRAWINGS

The features of the invention will become more apparent in the following detailed description in which reference is made to the appended drawings wherein:

FIG. 1 illustrates an example side-view diagram of a manufacturing system using two webs of plastic film material fed from spaced rolls

FIG. 2 illustrates an example front view diagram of the manufacturing system of FIG. 1;

FIG. 3 illustrates an example perspective view of a front panel and a back panel of a plastic film bag prior to being affixed to each other;

FIG. 4 illustrates an example notch in the front panel or back panel in a V-form;

FIG. 5 illustrates an example notch in the front panel or back panel in a slit-form;

FIG. 6 illustrates an example notch in the front panel or back panel in a half moon form;

FIG. 7 illustrates, according to an embodiment, secondary notches between adjacent small, triangular-shaped teeth;

FIG. 8 illustrates an example of the secondary notches and an end of a tear line meeting the middle of the secondary notches;

FIG. 9 illustrates an example of the secondary notches and an end of a tear line meeting near the top of the secondary notches;

FIG. 10 illustrates an example of the secondary notches and an end of a curved tear line meeting near the bottom of the secondary notches;

FIG. 11 illustrates an example where material has flowed at the base of the notch thereby taking the series of secondary notches away from their initial pre-sealing position centered at the end of the tear line;

FIG. 12 illustrates an example where the tear line is formed with a plurality of radiating lines joined at the end of the primary tear line;

FIG. 13 illustrates a series of secondary notches as an array;

FIG. 14 illustrates a series of secondary notches as directed inwards; and

FIG. 15 is a flowchart for a method of fabricating a plastic film bag.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

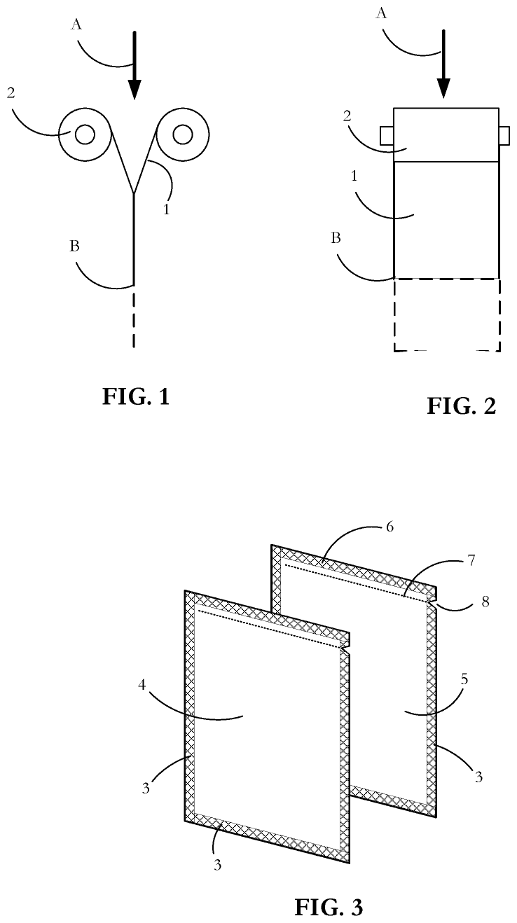

As shown in FIGS. 1 and 2, such a manufacturing system uses two webs 1 of plastic film material which are fed from spaced rolls 2. Parts of the webs are brought into contact at bottom and sides edge regions 3 of the front and back panels 4, 5 (FIG. 3). The panels are thermally welded, or otherwise affixed, to one another at the regions 3 to form the bag. In variations of the process for making more complex bags such as bags with more than two sides or bags with bases, other panels including gusset panels (not shown) are fed or inserted at positions adjacent the front and back panels for edge sealing. For simplicity, FIGS. 1 and 2 show the manufacture of a two-sided bag. Following thermal edge welding at the regions 3, the bag is loaded from the top (arrow A) with material to be distributed within the bag and the bag, with contained product, is fed vertically downwards. The front and back panels 4, 5 are then thermally welded to each other at a top seal region 6 and the bag is separated from a following bag by cutting though the top weld 6 as shown at B. A remaining part of the top weld region becomes the lower seal region of the next bag.

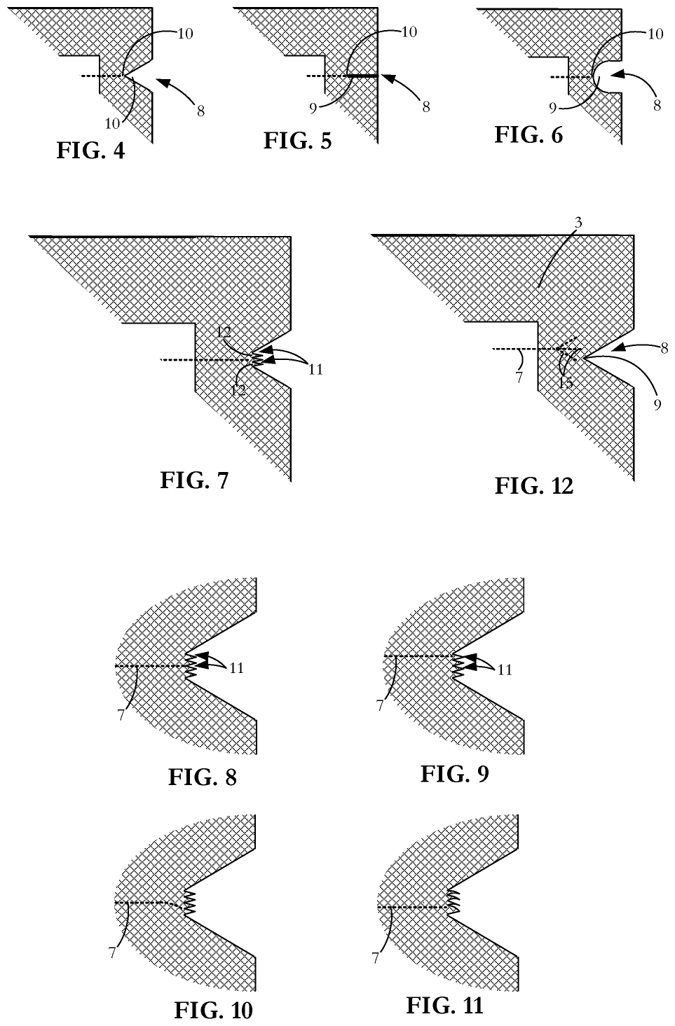

A common feature of this type of bag is a tear line 7 and a notch 8 as shown in FIG. 3, and, to a larger scale, in FIGS. 4 to 12. The notch 8 may be V-form (FIG. 4), slit-form (FIG. 5), half moon form (FIG. 6), or the like. The tear line 7 is typically a line of reduced strength which ends at or very close to the base or inner extremity 9 of the notch 8. Usually, a tear line is scored in each of the front and back panels during a film lamination process and before side edge thermal welding of the webs while the notch 8 is usually stamped out after side edge thermal welding. However, formation of the tear line and notch can be done in reverse and both can be done either before of after the basic bag structure has been made. The tear line 7 can be made for example by laser scoring as a continuous line or by a row of dints. The elements of the tear line are not so deep as to puncture the bag film and so affect sealing. Moreover, the tear line is not so deep that the bag will open by light handling: a deliberate tearing action is needed.

Ideally, the base of the edge notch 8 is coincident with the end of the tear line 7 at a single point 10, that point becoming an initiating tear site when the opener of the bag seeks to open the bag by gripping and pulling at either side of the notch 8. In operation, the user pulls apart the material at the two sides of the notch. The bag tears at the base of the notch 8 and propagates from the notch along the tear line 7.

Typically, plastic bags have been made of a combination of materials depending on the function a particular element or part of the bag must perform. For example, a plastic film used in bag production may have several plies which are glued or melded together in the film manufacturing process. Exemplary ply materials include polyethylene (known for durability, good tear resistance, good stretch resistance and thermal weldability), polyester (known for ease of receiving printed information but not good for thermal welding), and nylon (vey high strength). There is a burgeoning and welcome move in the plastic bag industry to make bags of recyclable materials. While combination ply materials do not lend themselves to recycling, items made solely of a polyethylene that can be thermally welded are recyclable.

One difficulty with using a single type polyethylene throughout the bag structure occurs in the manufacturing vertical form-fill-seal process and in related processes. Thus, one object of the design and operation of this type of process is to achieve positional coincidence of the notch inner extremity with the end of the tear line. If positional coincidence does not occur, then the user may have to exert much more effort to effect a beginning tear between the notch base and the tear line end in order for the main tear to propagate along the tear line. For example, this leads to popcorn being sprayed all over the theatre seat.

The above problem can be caused, or may be exacerbated, if bag construction is limited to a single type polyethylene. Thus, when polyethylene is heated in order to effect thermal welding, the polyethylene can, to some extent, flow laterally away from its start position leading to a loss of the desired positional coincidence.

Accordingly, in an embodiment, there is provided a plastic film bag having a front panel, a back panel, a first tear notch formed in one of the panels, the first tear notch having an opening at a first outer edge of the one panel, the first tear notch extending from the first outer edge to a first inner notch boundary part, the edge of the film at the first inner boundary part having a plurality of secondary tear mechanisms (in this case, secondary tear notches) spaced along said first inner boundary part, the secondary notches smaller in size than said first tear notch.

As used herein, the term “notch” is intended to cover also the terms indentation, incision, score and the like, and to cover also a space at the first inner boundary part extending inwardly between a pair of adjacent teeth, scallops or the like. Such notches can be of even or irregular depth, width, shape or size. In one implementation, as shown in FIG. 7, the secondary notches 11 are located between adjacent small, triangular-shaped teeth 12 formed in the plastic film, the notches 11, as a corollary, being inverted triangular spaces, each space having a base 13 where one tooth 12 joins the next adjacent tooth.

In most cases, following the side/bottom sealing step, the notch 8 and the end of the tear line are as shown in FIG. 8, with the tear line 7 aligned with the center of the linear series of secondary notches 11. The bases 13 of the multiple secondary notches 11 extending along the first inner notch boundary part 14 provide several possible sites, at any one of which, an initiating tear can begin and propagate to, and then along, the main tear line 7. The presence of multiple spaced secondary notch bases 13 means that if, following the sealing step, the positions of the primary notch base and the tear line end are misregistered or indistinct as shown in FIG. 9, then there is effectively a plurality of possible positional points where an initiating tear can start when a user seeks to open the bag. In practice, the initiating tear starts at the secondary notch base which is either closest to the end of the tear line or at that notch base, among the several secondary notch bases, where there is the least tear resistance between it and the tear line end. Usually, of course, the secondary notch base closest to the tear line end is also the same notch that has least tear resistance between it and the end of the tear line. For a different positional misregistration or a different pattern of flow of the melted polyethylene, the weakest region may be between a different one of the secondary notch bases and the end of the tear line.

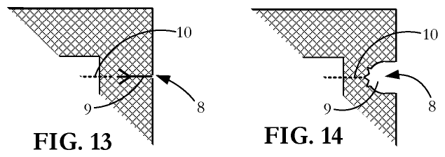

Although, as shown in FIGS. 7 to 11, the base of a primary notch is shown as formed with a vertical series of secondary notches particularly adapted for a horizontal tear line, the series can be arrayed in other than a vertical series. For example, for a bag to be opened from a primary notch formed in the top seal, the series of secondary notches may be a horizontal series or a linear series arrayed along an inclined line. For the primary notches shown in FIGS. 5 and 6, the series of notches can, for example, be arrayed as shown in FIGS. 13 and 14, respectively.

An alternative artefact of a manufacturing process in which the primary notches on the respective panels are not stamped through together in a single operation may mean that one or both of the primary notch bases of the front and back panels may not be positionally coincident with each other or with the tear line end after edge sealing. In this case, a similar situation pertains. That is, one of the series of secondary notch bases at one primary notch, although not centrally positioned in that primary notch, may be closer to the tear line end than the others in the series. The film material between that secondary notch base and the tear line end will be a notional linear tear region most susceptible to a beginning tear when the user pulls material at either side of the primary notch. Once the beginning tear reaches the tear line end the separation tear will propagate in the normal way along the tear line or lines.

The presence of secondary notches and, correspondingly, multiple initiating ‘tear sites’ seeks to address the problem of misregistration, whether it arises from a mechanical displacement or my plastic material flow during thermal welding. Thus, FIG. 10 is intended to show a situation where material has flowed at an end section of the tear line, so taking the tear line end itself away from the center of the series of secondary notches. FIG. 11 is intended to show a situation where material has flowed at the base of the notch thereby taking the series of secondary notches away from their initial pre-sealing position centered at the tear line end. When selecting the distribution and spacing of these tear sites, factors such as bag material properties and bag opening mechanics must be considered. In one structure the minimum tear site to tear site spacing was 0.05 centimetres.

In a further aspect of the invention as illustrated in FIG. 12, the end of the tear line 7 is formed with a plurality of radiating lines of weakness 15, these lines joined at the end of the tear line are the secondary tear mechanisms and have the same function as the secondary tear notches. That is, to limit the effort required to break open a bag if some misregistration or material flow has occurred in the assembly and sealing process. Multiple, secondary, initiating tear sites can be introduced by combining multiple secondary notches and the tear line radiating lines.

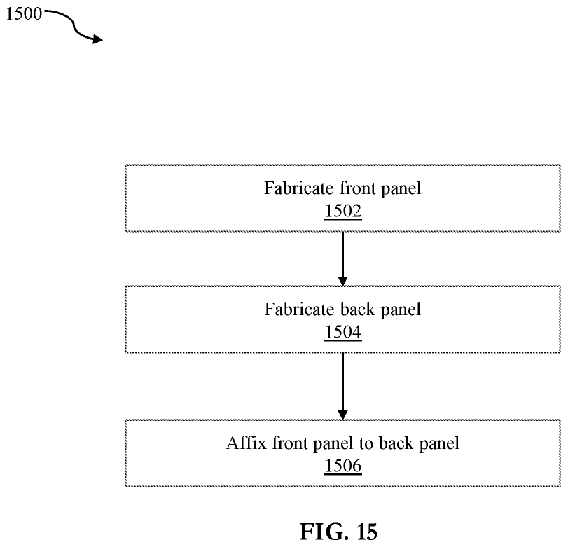

FIG. 15 illustrates a method for fabricating a plastic film bag 1500, in accordance with an embodiment. At block 1502, the front panel is fabricated, and such fabrication includes forming at least one back primary tear notch and a back primary tear line terminating at the back primary tear notch, and forming a plurality of back secondary tear mechanisms located within the back primary tear notch. At block 1504, the back panel is fabricated, and such fabrication includes forming at least one back primary tear notch and a back primary tear line terminating at the back primary tear notch, and forming a plurality of back secondary tear mechanisms located within the back primary tear notch. At block 1506, the front panel is affixed to the back panel along edges of the front panel and back panel.

Although the invention has been described with reference to certain specific embodiments, various modifications thereof will be apparent to those skilled in the art without departing from the spirit and scope of the invention as outlined in the claims appended hereto.

1. A plastic film bag comprising:
a front panel; and
a back panel affixed to the front panel along edges of the front panel and back panel,
wherein the front panel, the back panel, or both, define at least one primary tear notch and a primary tear line terminating at the primary tear notch, and wherein a plurality of secondary tear mechanisms are defined at the edge within the primary tear notch.

2. The plastic film bag of claim 1, wherein the plurality of secondary tear mechanisms comprise notches spaced along the boundary of the edge defining the primary tear notch, the secondary notches are smaller in size than the primary tear notch.

3. The plastic film bag of claim 2, wherein the secondary notches are defined between a plurality of portions of the edge that extend into the space defined by the primary notch.

4. The plastic film bag of claim 3, wherein the plurality of portions are triangular shaped teeth.

5. The plastic film bag of claim 2, wherein the secondary notches are defined by a plurality of indentations inwards at the edge defining the primary tear notch.

6. The plastic film bag of claim 1, wherein the plurality of secondary tear mechanisms comprise a plurality of radiating secondary tear lines joined at the end of the primary tear line.

7. The plastic film bag of claim 1, wherein the primary tear line extends from the edge defining the primary tear notch to an opposing edge of the front panel or back panel.

8. The plastic film bag of claim 1, wherein the front panel and back panel, or both, define two primary tear notches on opposing edges, and the primary tear line extends between the two primary tear notches.

9. A method for fabricating a plastic film bag, the method comprising:
fabricating a front panel;
fabricating a back panel; and
affixing to the front panel to the back panel along edges of the front panel and back panel,
wherein fabricating the front panel and fabricating the back panel comprises forming at least one primary tear notch and a primary tear line terminating at the primary tear notch, and forming a plurality of secondary tear mechanisms located at the edge within the primary tear notch.

10. The method of claim 9, wherein the plurality of secondary tear mechanisms comprise notches spaced along a boundary of the edge defining the primary tear notch, the secondary notches are smaller in size than the primary tear notch.

11. The method of claim 10, wherein the secondary notches are formed between a plurality of portions of the edge that extend into the space defined by the primary notch.

12. The method of claim 11, wherein the plurality of portions comprise triangular shaped teeth.

13. The method of claim 10, wherein the secondary notches are formed by cutting a plurality of indentations inwards at the edge defined by the primary notch.

14. The method of claim 9, wherein the plurality of secondary tear mechanisms comprise a plurality of radiating secondary tear lines joined at the end of the primary tear line.

15. The method of claim 9, wherein the primary tear line extends from the edge defining the primary tear notch to an opposing edge of the front panel or back panel.

16. The method of claim 9, wherein the front panel and back panel each are fabricated with two primary tear notches formed on opposing edges, and the primary tear line extends between the two primary tear notches.
